(19) United States
(12) Patent Application Publication
(10) Pub. No.: US 2016/0303748 A1
(43) Pub. Date: Oct. 20, 2016

(54) SURVIVAL KNIFE WITH LENS IN HANDLE

(71) Applicant: Seth Martinez, Chicago, IL (US)

(72) Inventor: Seth Martinez, Chicago, IL (US)

(21) Appl. No.: 15/097,695

(22) Filed: Apr. 13, 2016

Related U.S. Application Data
(60) Provisional application No. 62/147,367, filed on Apr. 14, 2015.

(51) Int. Cl. B26B 11/00; B26B 3/00; G02B 19/00; B26B 1/02

(52) U.S. Cl. CPC B26B 11/00; B26B 1/02; B26B 3/00; G02B 19/0042

(57) ABSTRACT

A knife having a handle and a blade secured to the handle. The handle includes an aperture which houses a lens. The lens can be held in the aperture with a compressible material. A cover may be disposed about the lens to protect it until use. The blade of the knife may comprise a fixed blade.

### RELATED APPLICATIONS

This application claims priority to U.S. Provisional Application Ser. No. 62/147,367 filed in Apr. 14, 2015, the entirety of which is incorporated herein by reference.

### FIELD OF THE INVENTION

This invention relates generally to a survival knife and more particular to a survival knife with a converging lens in a handle.

### BACKGROUND OF THE INVENTION

When presented with a survival situation, starting a fire may be one of most important things for an individual to accomplish. In such survival situations, it is generally desirable to conserve energy for any number of reasons, such as a decreased food supply. Thus, while there are many different methods in which a fire may be started, those methods that do not require significant energy to accomplish are preferred. For example, using a match or using a lens to start a fire requires very little energy.

Many different survival knifes currently exist that include various tools or features that can be used for starting fires. For example, many fixed blade survival knives include a compartment in the handle, such as the one disclosed in U.S. Pat. No. 4,669,186. By “fixed blade” it is meant that the blade and the handle do not rotate relative to each other. The compartments of the fixed blade survival knives may house many different tools, including, for example, a match. However, such compartments require the fire starting element to be present, and if it is not there when it is needed, it is of no use to the individual in the survival situation. Furthermore, matches are typically unusable once they have been wetted. Therefore, a lens would be more desirable as it is generally more durable compared to matches.

U.S. Pat. No. 4,669,186 further discloses that a lens can be included in a removable end cap that can be used to inspect the inner compartments of the knife. While the lens is not disclosed as comprising a lens capable of starting a fire, it is a separate, removable element that can be removed and thus may be easily lost.

In addition to fixed blade survival knives, there are many survival knives that comprise a plurality of implements or tools that may be folded out of a handle. One such knife is shown in U.S. Pat. No. 883,648. While these knives may include a lens with a more permanent connection, the lens could still break off, or the knife could become jammed, making the lens inaccessible.

Therefore, there remains a need for a knife that does not suffer from one or more of the drawbacks discussed above.

### SUMMARY OF THE INVENTION

Various embodiments of a survival knife have been invented in which a converging lens is fixedly mounted within the handle of the knife. This minimizes the chance that the lens and knife are separated.

Therefore, in a first embodiment of the invention, the present invention may be characterized broadly as providing a knife comprising a blade, a handle, and a lens. The blade is secured to the handle. The lens is disposed in an aperture of the handle so as to allow light to pass through the lens and through the handle.

In one or more embodiments of the present invention, the blade comprises a fixed blade.

In various embodiments of the present invention, the handle has a first end and a second end and the blade is secured to the handle proximate the first end. It is contemplated that the lens is disposed proximate the second end of the handle. It is also contemplated that the lens is disposed between the first end of the handle and the second end of the handle.

In some embodiments of the present invention, a compressible material is disposed between the lens and the handle.

In at least one embodiment of the present invention, a removable cover is disposed over the lens. It is contemplated that the removable cover plate is held in plate by friction. It is further contemplated that the removable cover plate is held in plate by interlocking detents.

In some embodiments of the present invention, the handle is made from carbon fiber, wood, rubber, plastic, thermoplastics, composites, bone, phenolics, and/or, metals.

In one or more embodiments of the present invention, the blade is made from carbon steel, stainless steel, tool steel, alloy steel, cobalt alloy, titanium alloy, ceramics, obsidian, and/or, plastic.

In various embodiments of the present invention, the lens is made of plastic.

In at least one embodiment of the present invention, the lens is made of glass.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

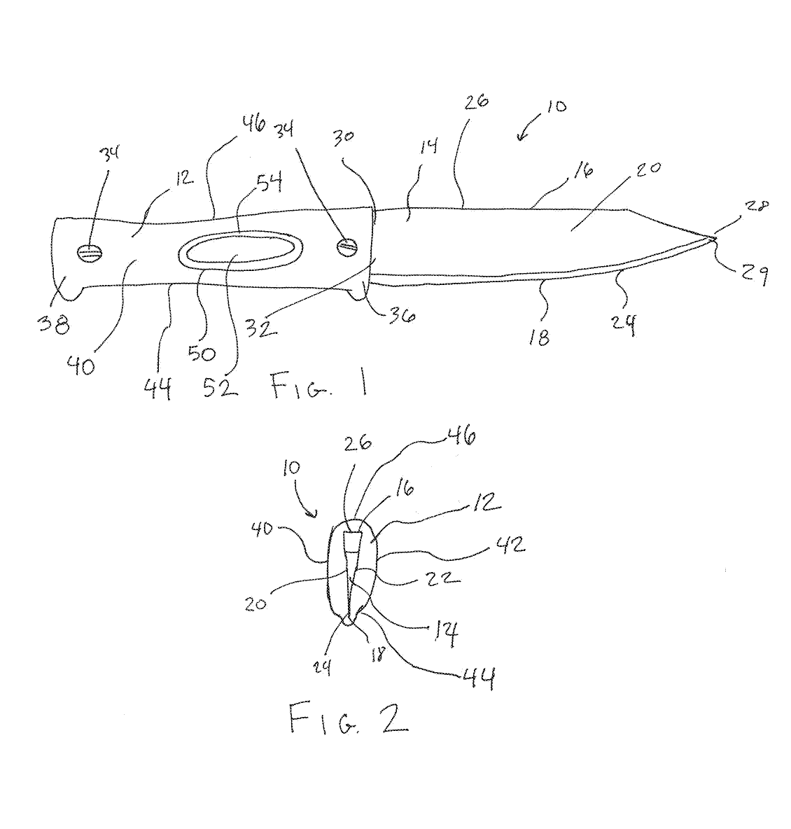

FIG. 1 shows a side view of a survival knife according to one or more embodiments of the present invention;

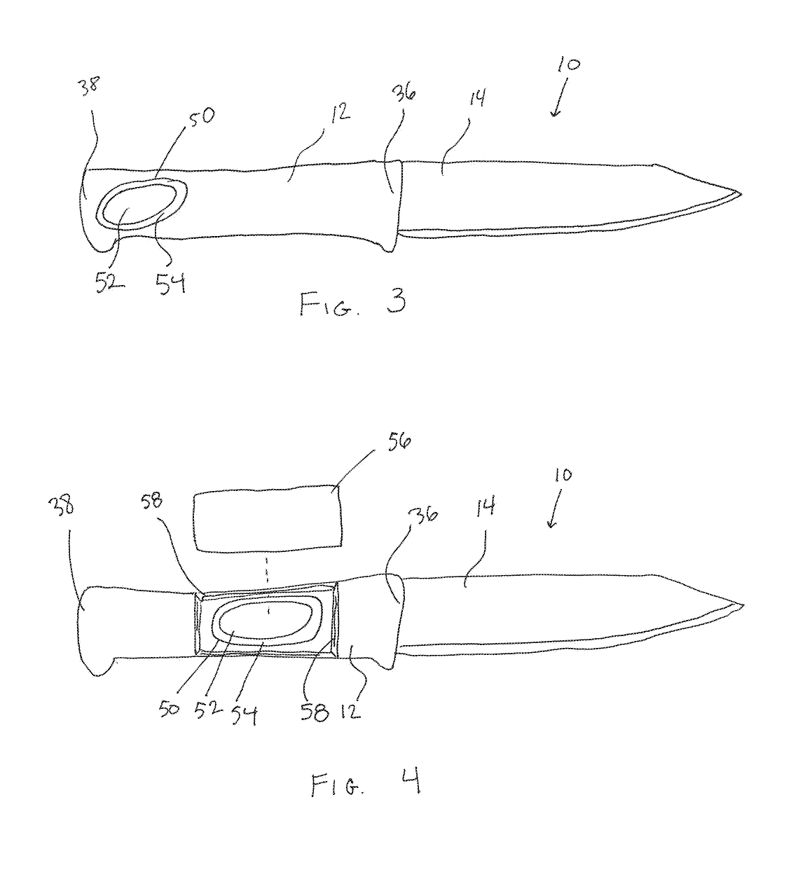

FIG. 2 shows a front view of the survival knife according to one or more embodiments of the present invention shown in FIG. 1;

FIG. 3 shows a side view of another survival knife according to one or more embodiments of the present invention;

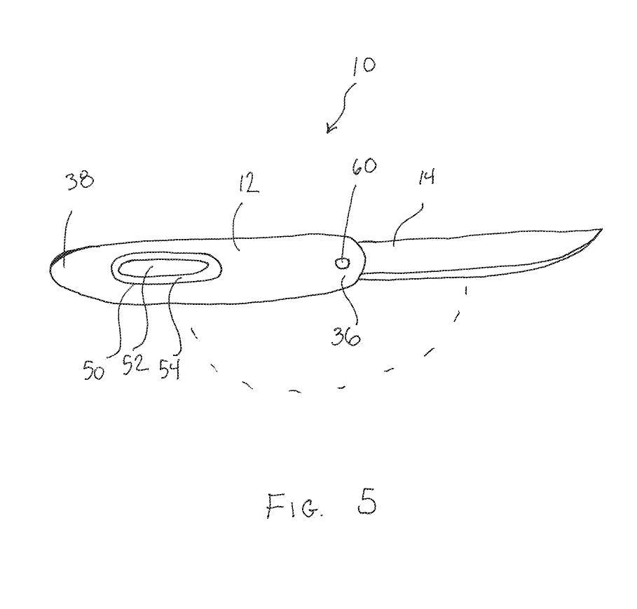

FIG. 4 shows a side view of another survival knife according to one or more embodiments of the present invention; and,

FIG. 5 shows a side view of another survival knife according to one or more embodiments of the present invention.

### DETAILED DESCRIPTION OF THE INVENTION

As mentioned above, one or more embodiments of a survival knife has been invented in which a converging lens is mounted within the handle of the knife. As used herein “converging lens” is intended to mean any lens capable of focusing a light beam to a concentrated focal point which could be used to start a fire. Such converging lenses include a convex lens, a Fresnel lens, a magnifying lens, or even a piece of glass or other material that has a curved surface and is able to focus light into a concentrated beam. By mounting the lens in the knife, it is less likely that the knife and lens can be accidentally separated.

With these general principles in mind, one or more embodiments of the present invention will be described with the understanding that the following description is not intended to be limiting.

As shown in FIGS. 1 to 5, in various embodiments of the present invention, a knife 10 comprises a handle 12 and a blade 14. The blade 14 is secured to the handle 12.

In the embodiments shown in FIGS. 1 to 4, the blade 14 and the handle 12 are not movable relative to each other and thus, the blade 14 comprises a fixed blade. The blade 14 may be made of any suitable material including, for example, carbon steel, stainless steel, tool steel, alloy steel, cobalt alloy, titanium alloy, ceramics, obsidian, and plastic.

As shown in FIGS. 1 and 2, the blade 14 includes a first edge 16, a second edge 18, both formed from a first surface 20 and a second surface 22. The edges 16, 18 are disposed on opposite sides of the blade 14. For example, as depicted in the orientation in FIGS. 1 and 2, the first edge 16 is on top of the blade 14 and the second edge 18 is on the bottom of the blade 14. The use of “top” and “bottom” herein, as well as other similar descriptions that follow are merely exemplary and illustrative and should not be considered to limit the present invention.

At least one of the edges 16, 18 of the blade 14 comprises a cutting edge 24. Although not depicted as such, both edges 16, 18 of the blade 14 may comprise a cutting edge 24. However, as depicted, the second edge 18 comprises the cutting edge 24, while the first edge 16 comprises a non-cutting edge 26. As is known, the non-cutting edge 26 may comprise a flat, or semi-flat surface. Additionally, although not depicted as such, the cutting edge 24 may include a serrated portion.

Additionally, the two surfaces 20, 22 of the blade 14 are disposed on opposite sides of the blade 14. For example, as depicted in the orientation in FIGS. 1 and 2, the first surface 20 is disposed on the left side of the blade 14 and the second surface 22 is located on the right side of the blade. The first and second surfaces 20, 22 are preferably flat or generally flat.

Finally, the blade 14 may also include a first end 28, that may comprise a tip 29, and a second end 30, that may comprise a base 32. The base 32 of the blade 14 may extend into the handle 12 in order to be secured thereto with, for example, one or more fasteners 34, or adhesive or any other securing element. Additionally, it is contemplated that the handle 12, or a portion thereof, and the blade 14 are integral, i.e., made from the same piece of material.

The handle 12 includes a first end 36 and a second end 38. The handle 12 may be comprised of any suitable material including, carbon fiber, wood, rubber, plastic, thermoplastics such as acrylic-polyvinyl chloride or the like, composites, bone, phenolics, and metals. The blade 14 may be secured proximate the first end 16 of the handle 12.

The handle 12 may include includes two side surfaces 40, 42, a front surface 44, and a back surface 46. The side surfaces 40, 42, the front surface 44, the back surface 46, or any combination thereof may include a texture designed to provide a better gripping surface for a user. The side surfaces 40, 42 are preferably disposed on opposite sides of the handle 12.

Alternatively, the handle 12 may be circular (or generally circular) in which the handle 12, when viewed the along a longitudinal axis (not shown) of the handle 12 extending from the first end 36 to the second end 38, comprises a circular shape. By “generally circular” it is meant that the shape of the handle 12, when viewed the along the longitudinal axis of the handle 12, extending from the first end 36 to the second end 88, comprises a similar shape, such as pentagons, hexagons, heptagons, octagons, nonagons, decagons, etc. Again, in such an instance, the texture of the handle 12 may be configured to increase the ability of a user to grip same.

According to the various embodiments of the present invention, an aperture 50 is disposed within the handle 12. The aperture 50 preferably extends through the entire handle 12, i.e., through both of the two side surfaces 40, 42 (so that an light passing through the aperture 50 will pass through the handle 12). As shown in FIG. 1, the aperture 50 may be disposed between the first end 36 of the handle 12 and the second end 38 of the handle 12. In contrast, as shown in FIG. 3, the aperture 50 may be disposed proximate the second end 38 of the handle 12. Other configurations are also possible.

In any configuration, a converging lens 52 is disposed within the aperture 50 of the handle 12. As such, any light that passes through the handle 12 via the aperture 50 will pass through the converging lens 52. The converging lens 52 may be made from any material such as plastic or glass; however, plastic is preferred due it its durability. Additionally, the converging lens 52 may have a circular, oval, or other shape.

A compressible material 54 may be disposed between an inner surface of the aperture 50 and an outer edge of the converging lens 52. The compressible material 54 comprises a material that absorbs physical forces, for example from a fall or being hit against an object. Preferred materials for the compressible material 54 include a synthetic rubber like polychloroprene, silicone rubber, and polymer foam, to name a few.

As shown in FIG. 4, a cover plate 56 may be utilized to cover the aperture 50 and more particularly the converging lens 52 to protect the converging lens 52 from damage or dirt when not in use. The cover plate 56 may be held in place on the handle 12 by a friction fit or the handle 12 and the cover plate 56 may be provided with interlocking detents 58. Although not depicted as such, the cover plate 56 may be secured to the handle with, for example, a hinge to allow the cover plate 56 to be pivotably opened and closed.

Turning to FIG. 5, in contrast to the embodiments shown in FIGS. 1 to 4, in some embodiments of the presnetn invention, the blade 14 of the knife 10 may be movable relative to the handle 12. More specifically, a pin 60 may secure the blade 14 to the handle 12 and act as a pivot, allowing the blade 14 to rotate out along the dashed line shown in FIG. 5 to an opened position (as shown). The converging lens 52 may be used when the knife 10 has been opened. It is also contemplated to position the aperture 50 of the handle 12 in the knife 10 of FIG. 5 such that the converging lens 52 can be used without needing to open the knife 10—for example by disposing the converging lens 52 proximate the second end 38 of the knife 10.

In any of the foregoing embodiments, or any number of modifications thereof, by utilizing a lens permanently fixed in the handle of the knife, the chance that the lens (i.e., the fire starting element) may become separated from the knife is minimized. This provides a knife that is more likely to have the fire starting element when it is needed, a time that may not be known in advance.

It should be appreciated and understood by those of ordinary skill in the art that various other components such as tools, compartments, sheaths, lanyards, etc. were not shown in the drawings as it is believed that the specifics of same are well within the knowledge of those of ordinary skill in the art and a description of same is not necessary for practicing or understanding the embodiments of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A knife comprising:
a blade and a handle, the blade being secured to the handle; and,
a lens disposed in an aperture of the handle so as to allow light to pass through the lens and through the handle.

2. The knife of claim 1, wherein the blade comprises a fixed blade.

3. The knife of claim 1 wherein the handle has a first end and a second end, the blade being secured to the handle proximate the first end, and the lens being disposed proximate the second end of the handle.

4. The knife of claim 1 wherein the handle has a first end and a second end, the blade being secured to the handle proximate the first end, and the lens being disposed between the first end of the handle and the second end of the handle.

5. The knife of claim 1 further comprising a compressible material disposed between the lens and the handle.

6. The knife of claim 1 further comprising a removable cover plate disposed over the lens.

7. The knife of claim 6 wherein the removable cover plate is held in plate by friction.

8. The knife of claim 6 wherein the removable cover plate is held in plate by interlocking detents.

9. The knife of claim 1 wherein the handle comprises at least one material selected from the group consisting of: carbon fiber; wood; rubber; plastic; thermoplastics; composites; bone; phenolics; and, metals.

10. The knife of claim 1 wherein the blade comprises at least one material selected from the group consisting of: carbon steel; stainless steel; tool steel; alloy steel; cobalt alloy; titanium alloy; ceramics; obsidian; and, plastic.

11. A knife comprising:
a blade and a handle, the blade being secured to the handle so as to be fixed in relation to each other; and,
a lens disposed in an aperture of the handle so as to allow light to pass through the lens and through the handle.

12. The knife of claim 11 wherein the handle has a first end and a second end, the blade being secured to the handle proximate the first end, and the lens being disposed proximate the second end of the handle.

13. The knife of claim 11 wherein the handle has a first end and a second end, the blade being secured to the handle proximate the first end, and the lens being disposed between the first end of the handle and the second end of the handle.

14. The knife of claim 11 further comprising a compressible material disposed between the lens and the handle.

15. The knife of claim 11 further comprising a removable cover plate disposed over the lens.

16. The knife of claim 15 wherein the removable cover plate is held in plate by friction.

17. A knife comprising:
a blade pivotably secured to a handle with a pin; and,
a lens disposed in an aperture of the handle so as to allow light to pass through the lens and through the handle.

18. The knife of claim 17 wherein the handle has a first end and a second end, the blade being secured to the handle proximate the first end, and the lens being disposed proximate the second end of the handle.

19. The knife of claim 17 wherein the handle has a first end and a second end, the blade being secured to the handle proximate the first end, and the lens being disposed between the first end of the handle and the second end of the handle.

20. The knife of claim 17 further comprising a compressible material disposed between the lens and the handle.
